(19) United States
(12) Patent Application Publication
(10) Pub. No.: US 2007/0094336 A1
(43) Pub. Date: Apr. 26, 2007

(54) Asynchronous server synchronously storing persistent data batches

(75) Inventor: Malcolm E. Pearson, Kirkland, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/256,751

(22) Filed: Oct. 24, 2005

(51) Int. Cl. G06F 15/16

(52) U.S. Cl. 709/206; 709/204; 707/104.1

(57) ABSTRACT

An asynchronous conversation state machine asynchronously sends and asynchronously receives messages for storing in batches in an intermediate storage. A synchronous storage engine receives the batches of messages from the intermediate storage. Particular batches of messages are stored in the storage engine based on their parameters.

### BACKGROUND

Increasing throughput in a data handling system is an area where increasing emphasis is being directed. Asynchronous mechanisms generally model the protocol conversation best; while synchronous mechanisms are generally used to implement the data store. For example, one challenge is achieving an optimal system throughput for an SMTP relay server that persists the email messages that it receives in a database, or other storage engine that does not support an asynchronous programming model where the SMTP protocol handling is implemented using asynchronous programming patterns. Although it is theoretically possible to build a database that supports an asynchronous programming model, such an implementation has limited practical and commercial execution. In at least certain implementations, this leads to a pattern mismatch between storage engines and optimization of servers, especially for servers employing the SMTP protocol.

Thus, increased system throughput may have advantages in certain systems.

### SUMMARY

In one embodiment, a batch point between an asynchronous conversion state machine and a synchronous storage engine transfers batch groups of messages to the engine for synchronous execution.

In another embodiment, batch groups may be periodically transferred between an asynchronous conversion state machine and a synchronous storage engine as a function of the parameters of one or more of the batch groups.

Other features will be in part apparent and in part pointed out hereinafter.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates one embodiment of an operating environment of an embodiment of the invention.

FIG. 2 is a block diagram of one embodiment of the invention.

FIG. 3 is a flow chart illustrating one embodiment of the invention for creating and transferring batch groups.

FIG. 4 is a flow chart illustrating background processing of batches that have timed-out.

Corresponding reference characters indicate corresponding parts throughout the drawings.

### DETAILED DESCRIPTION

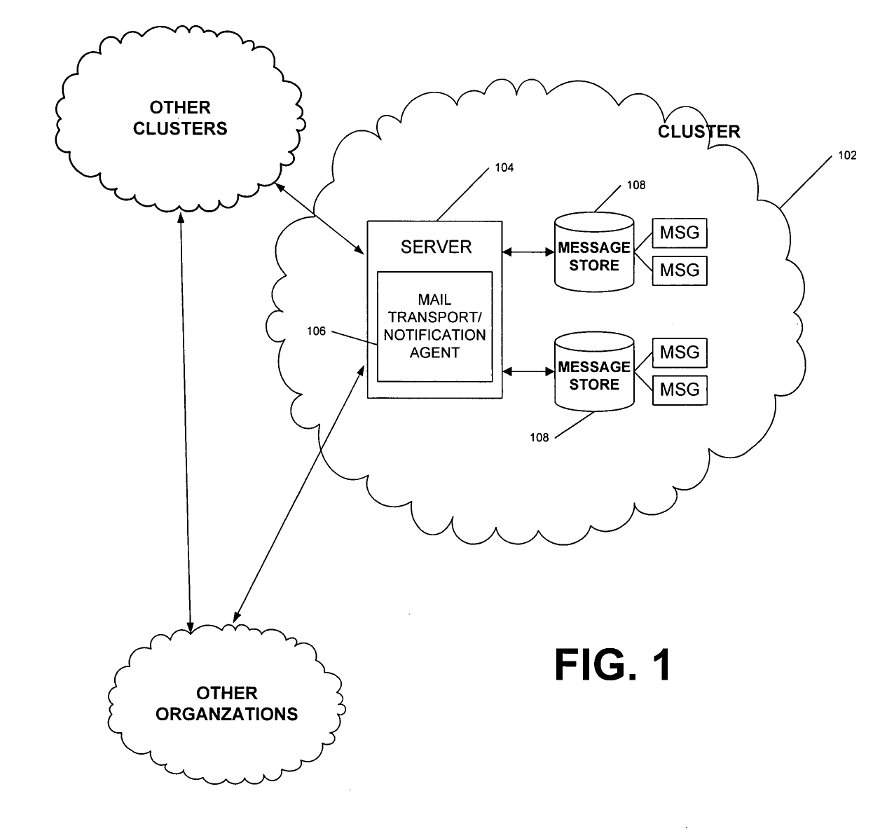

As illustrated in FIG. 1, one embodiment of an operating environment of an embodiment of the invention includes various clusters and organizations that are transmitting messages such as mail therebetween. Reference character 102 illustrates one embodiment of an exemplary cluster. Cluster 102 includes a server 104 having a executable mail transport/notification agent 106 for sending and receiving mail to and from other clusters. In addition, the mail transport agent (MTA) sends and receives mail to various message stores 108 as well as relaying mail to other MTAs (e.g., other organizations and/or other clusters).

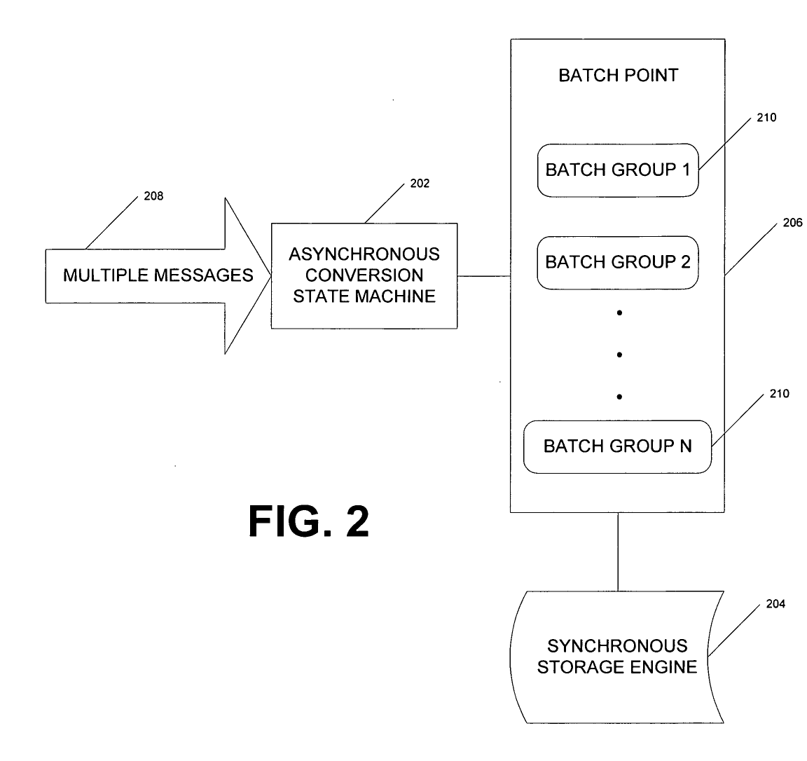

One embodiment of the present invention as illustrated in FIG. 2 is directed to an asynchronous conversion state machine 202 such as a server of the SMTP protocol for use in such an environment. Such machines 202 typically serve many concurrent connections to achieve preferment message transfer. Concurrent connections are optionally used due to the possibility of high latency on individual message transfer and due to the structure of the protocol and latency of the underlying network. Since using a thread to execute each such concurrent connection consumes a large amount of system resources (e.g., memory for stack/state space, and CPU to switch between thread contexts), threads are expensive.

In order to minimize the disk expense in the context of data storage, a synchronous storage engine 204 is used for the protocol implementation. Thus, the combination of an intermediate storage, referred to herein as a batch point 206 (which may be implemented within the system or as a separate component, such as a server), between the asynchronous conversion state machine 202 and the synchronous storage engine 204 according to one embodiment of the invention provides a system to bridge these approaches while achieving more optimal performance. Such a system permits an efficient dialog of sending, parsing, receiving and responding to occur between the asynchronous machine 202 and the synchronous storage engine 204. The engine 204 effectively receives, computes, initiates I/O and sends messages more efficiently. For example, messages can be efficiently reordered within the storage engine 204 for one read and one write. Synchronous storage engines 204 may include but are not limited to any synchronous database, an ISAM (Index Sequential Access Method) store [or SQL]or any other synchronous configuration for containing fields together with a set of operations for searching, sorting, recombining, and/or other functions.

As multiple messages 208 become available asynchronously to the state machine 202, the messages 208 must be updated against the synchronous storage engine 204. To accomplish the updating, the messages 208 as passed by the state machine 202 to the batch point 206, along with a mechanism to notify the protocol, or other message handler (e.g. categorizer; distribution list expansion agent; recipient resolver; and/or messaging policy enforcer), send or receive handler, archival mechanisms etc) when the update has been performed. Updating includes initial creation, deletion or modification.

As new messages arrive, they are collected in batches by the batch point 206. In the case where multiple processors are passing messages 208 to the batch point 206, an interlocked mechanism may be used to manage the batches to minimize the cost of inter-processor synchronization. For example, the interlock mechanism may manage reading, testing and modifying memory while a bus is locked. In the case of multiple CPUs accessing a memory at the same time, management of reading, testing and modifying to build a batch group within a stack may be employed.

As work collects within the batch point 206, batches become ready for execution and, in one embodiment, the batch point 206 may initiate transfer to the storage engine 204. In another embodiment, the state machine 202, the storage engine 204 or an external command from an external source may initiate transfer to the storage engine 204. Parameters that may be used to determine whether a batch 210 is ready to be triggered for transmission to the storage engine 204 include (but are not limited to): age of the batch (e.g., age of oldest message or age of date of creation of the batch), how many messages are in the batch (e.g., total number of messages or total number of a particular type of message), and/or amount of I/O associated with the batch (e.g., large attachments or many recipients). In the case of an SMTP server, these parameters can be tuned to adjust the SMTP protocol latency and transaction size, as storage engines are better able to optimize disk I/O by combining multiple operations into a single batch.

At this point, it is contemplated that any one or more of multiple possible strategies may be used to schedule a thread to execute the transmission of the batch or batches 210 ready for storing into the storage engine 204. For example, the strategies may include: hijacking a thread that was used to pass the last item into the batch, identifying and using a single background thread, employing multiple asynchronously scheduled background threads, or selecting a thread to avoid context switching and locks.

In the case of a machine 202 employing the SMTP protocol, acknowledgement of messages to the state machine 202 by the batch point 206 must be delayed until the batch 210 has been committed to the storage engine. If the time-out is increased, then a single connection with a single message will take longer to be acknowledged. But, with multiple concurrent messages, messages from different connections will collect to form a ready batch, allowing these to be acknowledged at the SMTP level and allowing the connections to send more messages.

A further possible optimization is to allow work subsequent to the time of receipt of the original message to proceed as soon as the message is added to the batch 210. In other words, the batch 210 is transmitted from the batch point 206 to the storage engine 204 as soon as the message which triggers the batch transfer is received by the batch point 206. According to the above optimization in one optional configuration, the message may be relayed to another point of responsibility before the batch is executed. In this case, the resulting message delete should cancel the pending message save so I/O may be completely avoided.

The batch point 206 typically has at least some form of computer readable media. Computer readable media, which include both volatile and nonvolatile media, removable and non-removable media, may be any available medium that may be accessed by batch point 206. By way of example and not limitation, computer readable media comprise computer storage media and communication media. Computer storage media include volatile and nonvolatile, removable and non-removable media implemented in any method or technology for storage of information such as computer readable instructions, data structures, program modules or other data.

For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by batch point 206. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The batch point 206 typically has some form of system memory including computer storage media in the form of removable and/or non-removable, volatile and/or nonvolatile memory. In the illustrated embodiment, system memory includes read only memory (ROM) and random access memory (RAM).

The batch point 206 may operate in a networked environment using logical connections to one or more remote computers, such as a remote computer. The remote computer may be a personal computer, a server, a router, a network PC, a peer device or other common network node, and typically includes many or all of the elements described above relative to batch point 206. The logical connections depicted in FIG. 1 include a local area network (LAN) and a wide area network (WAN), but may also include other networks. LAN and/or WAN may be a wired network, a wireless network, a combination thereof, and so on. Such networking environments are commonplace in offices, enterprise-wide computer networks, intranets, and global computer networks (e.g., the Internet).

When used in a local area networking environment, batch point 206 is connected to the LAN through a network interface or adapter. When used in a wide area networking environment, batch point 206 typically includes a modem or other means for establishing communications over the WAN, such as the Internet. The modem, which may be internal or external, is connected to system bus via the user input interface, or other appropriate mechanism. In a networked environment, program modules depicted relative to batch point 206, or portions thereof, may be stored in a remote memory storage device (not shown). By way of example, and not limitation, FIG. 1 illustrates remote application programs as residing on the memory device. The network connections shown are exemplary and other means of establishing a communications link between the computers may be used.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XML) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, batch point 206 executes computer-executable instructions such as those illustrated in the figures to implement aspects of the invention.

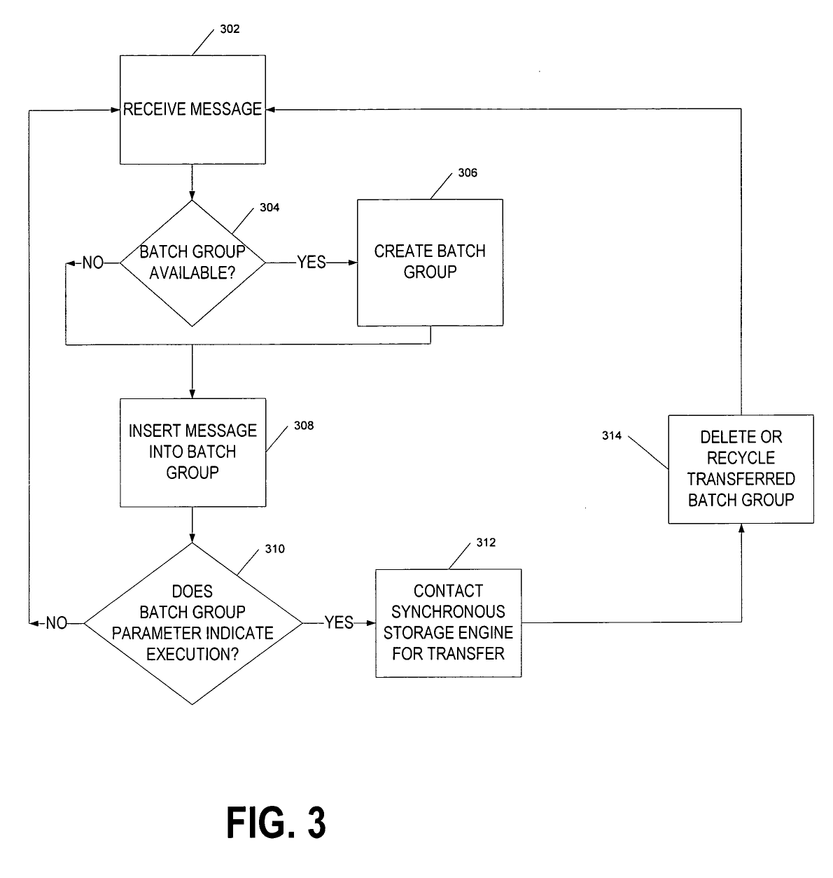

FIG. 3 is a flow chart illustrating one embodiment of the invention for creating and transferring batch groups. After the state machine receives a message at 302, the machine determines at 304 whether a batch group is available in the batch point server to which the message may be added. If not, a batch group is created at 306. If so, the message is inserted into the batch group of the batch point server at 308. After inserting the message into a particular batch group, the particular batch group is evaluated at 310 by the batch point server to determine whether a parameter of the particular batch group indicates that the particular batch group should be executed by transfer to the batch point server. For example, as noted above, various parameters of a batch group may be used to trigger execution of the group. If age is a trigger parameter, the age of the particular batch group would be evaluated at 310. If the age is greater than a threshold, the batch point server would contact the synchronous storage engine at 312 to transfer the particular batch group. Once the transfer is complete, the particular batch group is deleted or recycled at 314 and the process returns to 302 so that the state machine is ready to receive the next message. A batch can be recycled. For example, instead of freeing the memory associated with a particular batch, it may be more efficient to place the particular batch that is no longer in use in a collection for later use when a new empty batch is required. If at 310 the age is less than the threshold, the process returns to 302 so that the state machine is ready to receive the next message.

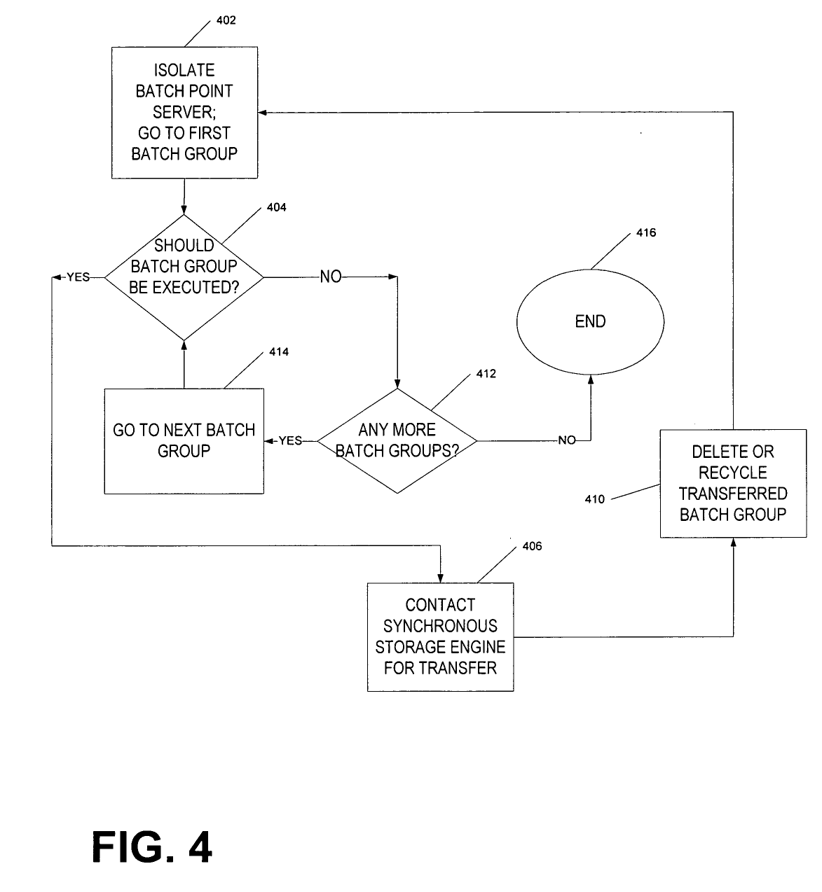

FIG. 4 is a flow chart illustrating one embodiment of the invention for or periodically evaluating and transferring batch groups. In one embodiment, the batch point 206 intermittently, routinely, periodically and/or in response to a command from the state machine 202, the storage engine 204 or some other external source reviews the batch groups to determine whether any of the groups are ready to be transmitted to the storage engine 104. At 402, the batch point server is temporarily isolated from the state machine and the first batch group is identified. If the batch point server determines at 404 that the batch group parameter meets an execution criteria, the batch point server contacts the storage engine at 406 to transfer the batch group until the transfer is complete and deleted at 410. If the batch point server determines at 404 that the batch group parameter does not meet the execution criteria and other batch groups have not been evaluated as determined by 412, the batch point server proceeds to evaluate the next batch group at 414 and 404. If the batch point server determines at 404 that a batch group parameter does not meet the execution criteria and all batch groups have been evaluated as determined by 412, the batch point server ends at 416. The execution criteria may be any factor including the parameters noted above that may be used to trigger batch 210 for transmission to the storage engine 204, e.g., age of the batch (e.g., age of oldest message or age of date of creation of the batch), how many messages are in the batch (e.g., total number of messages or total number of a particular type of message), and/or amount of I/O associated with the batch (e.g., large attachments or many recipients).

Having described various embodiments of the invention in detail, it will be apparent that modifications and variations are possible without departing from the scope of the various embodiments of the invention as defined in the appended claims.

### EXAMPLES

The following non-limiting examples are provided to further illustrate exemplary embodiments of the present invention.

The order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein. For example, it is contemplated that executing or performing a particular element before, contemporaneously with, or after another element is within the scope of the various embodiments of the invention.

When introducing elements of the various embodiments of the present invention, the articles “a”, “an”, “the” and “said” are intended to mean that there are one or more of the elements. The terms “comprising”, “including” and “having” are intended to be inclusive and mean that there may be additional elements other than the listed elements. In view of the above, it will be seen that the several advantageous results attained.

As various changes could be made in the above constructions, products, and methods without departing from the scope of the various embodiments of the invention, it is intended that all matter contained in the above description and shown in the accompanying drawings shall be interpreted as illustrative and not in a limiting sense.

What is claimed is:

1. A system comprising:
An intermediate storage;
An asynchronous conversation state machine for asynchronously sending and asynchronously receiving messages, said machine storing said received messages in batches in the intermediate storage;
A synchronous storage engine for receiving the batches of messages from the intermediate storage;
Wherein the intermediate storage causes a particular one of the batches of messages to be stored in the storage engine.

2. The system of claim 1 wherein the intermediate storage causes a particular one of the batches of messages to be stored in the storage engine as a function of a parameter of the particular batch.

3. The system of claim 2 wherein the parameters comprises at least one of an age of the messages of the particular batch, a number of messages in the particular batch, and an amount of I/O associated with the particular batch.

4. The system of claim 3 wherein the state machine comprises an SMTP server having a protocol latency and a transaction size and wherein the intermediate storage causes a particular one of the batches of messages to be stored in the storage engine as function of the protocol latency and the transaction size of the SMTP server.

5. The system of claim 1 wherein the state machine comprises an SMTP server having a protocol latency and a transaction size and wherein the intermediate storage causes a particular one of the batches of messages to be stored in the storage engine as function of the protocol latency and the transaction size of the SMTP server.

6. The system of claim 1 wherein the intermediate storage evaluates the batches stored in the intermediate storage to identify batches to be stored in the storage engine and wherein the intermediate storage engine causes the identified batches to be stored in the storage engine.

7. The system of claim 6 wherein the intermediate storage evaluates the batches according to a parameter of each of the batches and wherein the intermediate storage engine causes a particular one of the identified batches to be stored in the storage engine as a function of the parameter of the particular identified batch.

8. The system of claim 7 wherein the parameters comprises at least one of an age of the messages of the particular identified batch, a number of messages in the particular identified batch, and an amount of I/O associated with the particular identified batch.

9. The system of claim 7 wherein the state machine comprises an SMTP server having a protocol latency and a transaction size and wherein the intermediate storage causes the particular identified batch to be stored in the storage engine as function of the protocol latency and the transaction size of the SMTP server.

10. The system of claim 1 wherein the intermediate storage deletes or recycles batches transferred to the storage engine.

11. A computerized method comprising:
asynchronously receiving messages,
storing 308 said received messages in batches in an intermediate storage;
receiving 314 the batches of messages from the intermediate storage; and
storing a particular one of the batches of messages in a synchronous storage engine.

12. The method of claim 11 wherein storing comprises storing a particular one of the batches of messages in the storage engine as a function of a parameter of the particular batch.

13. The method of claim 12 wherein the parameters comprises at least one of an age of the messages of the particular batch, a number of messages in the particular batch, and an amount of I/O associated with the particular batch.

14. The method of claim 12 wherein asynchronously receiving comprises receiving via an SMTP protocol and wherein the parameters are a function of a protocol latency and a transaction size of the receiving.

15. The method of claim 11, wherein one or more computer-readable media have computer-executable instructions for performing the method of claim 11.

16. The method of claim 11 wherein at least one of the following strategies may be used to schedule a thread to execute the transmission of a particular batch for storing into the storage engine: hijacking a thread that was used to pass the last item into the particular batch, identifying and using a single background thread, employing multiple asynchronously scheduled background threads, and selecting a thread to avoid context switching and locks.

17. The method of claim 11 further comprising transmitting a batch from the batch point to the storage engine as soon as a message which triggers the batch transfer is received by the batch point.

18. In a system comprising:
An asynchronous conversation state machine for asynchronously sending and asynchronously receiving messages; and
A synchronous storage engine for storing batches of messages;
the improvement comprising an intermediate storage 106 for storing in batches messages received from the state machine and for causing a particular one of the batches of messages to be stored in the storage engine.

19. The system of claim 18 wherein the intermediate storage causes a particular one of the batches of messages to be stored in the storage engine as a function of a parameter of the particular batch.

20. The system of claim 19 wherein the parameters comprises at least one of an age of the messages of the particular batch, a number of messages in the particular batch, and an amount of I/O associated with the particular batch.
